(19) United States
(12) Patent Application Publication
(10) Pub. No.: US 2008/0310359 A1
(43) Pub. Date: Dec. 18, 2008

(54) Method and Apparatus for Sharing Resources in a Wireless System

(76) Inventors: Sean Michael McBeath, Keller, TX (US); Jack Anthony Smith, Valley View, TX (US); Anthony C.K. Soong, Plano, TX (US); Jianmin Lu, San Diego, CA (US)

Correspondence Address: Slater & Matsil, L.L.P., 17950 Preston Road, Suite 1000, Dallas, TX, 75252, US

(21) Appl. No.: 12/134,025

(22) Filed: Jun. 5, 2008

Related U.S. Application Data
(60) Provisional application No. 60/944,462, filed on Jun. 15, 2007.

(51) Int. Cl. H04Q 7/00

(52) U.S. Cl. 370/329

(57) ABSTRACT

A method and apparatus of signaling radio resource allocation in a wireless communication system comprises establishing a set of virtual resources; assigning one or more of the virtual resources to one or more mobile stations; transmitting a remapping bitmap to the mobile stations, wherein the remapping bitmap contains a resource availability bitmap and a virtual resource bitmap; and transmitting packets to the mobile stations or receiving packets from the mobile stations using the respective radio resources which are derived for the respective mobile stations from the remapping bitmap.

This application claims priority to U.S. Provisional Patent Application No. 60/942,324 filed Jun. 15, 2007, entitled “Method and Apparatus for Sharing Resources in a Wireless System” which application is hereby incorporated herein by reference.

### CROSS-REFERENCE TO RELATED APPLICATIONS

This application is related to the following provisional U.S. patent applications, each of which is incorporated herein by reference: U.S. Provisional Patent Application No. 60/944,466 filed Jun. 15, 2007; U.S. Provisional Patent Application No. 60/944,469 filed Jun. 15, 2007; and U.S. Provisional Patent Application No. 60/944,477 filed Jun. 15, 2007. Further, this application is related to the following non-provisional patent applications, each of which is incorporated herein by reference: U.S. patent application Ser. No. ______, filed ______ (Attorney Docket No. HW07FW050); U.S. patent application Ser. No. ______, filed ______ (Attorney Docket No. HW07FW051); and U.S. patent application Ser. No. ______, filed ______ (Attorney Docket No. HW07FW052).

### FIELD OF THE INVENTION

The present invention generally relates to allocation of radio resources for transmission in a wireless communication system. Specifically, the present invention relates to a novel method of signaling the allocation of radio resource for transmission in, e.g., orthogonal frequency division multiplexing (OFDM) and orthogonal frequency division multiple access (OFDMA) communication systems, and the resulting systems.

### BACKGROUND OF THE INVENTION

In an OFDMA communication system, the time-frequency resources of the system are shared among a plurality of mobile stations. The base station assigns resources to mobile stations using an assignment message, which is transmitted as part of a control channel. To minimize control channel overhead, it is known for the base station to make persistent assignments, wherein the assignment message is transmitted to the mobile station initially to indicate the assigned time-frequency resource, and then the base station uses the same time-frequency resource for subsequent transmissions to the mobile station. These transmissions can be hybrid automatic repeat request (HARQ) transmissions of the same packet or for subsequent transmissions of different packets. The initially assigned time-frequency resource is maintained by the base station for the mobile station until a timer elapses, a voice over internet protocol (VoIP) talk-spurt is completed, a VoIP call is completed, a certain number of negative acknowledgements is determined by the base station, or until the resource is explicitly or implicitly de-assigned by the base station.

During the period of the persistent allocation, there are times when the base station does not have any new packets to transmit to the mobile station. For example, if the mobile station has acknowledged a HARQ packet before the maximum number of HARQ transmission attempts is reached, the base station may not have a new packet for the mobile station. Alternatively, if the base station has determined a discontinuous transmission (DTX) state for a VoIP mobile station, the base station may not have a packet to transmit to the mobile station. During such times, it is desirable for the base station to temporarily allocate the persistently assigned resource for a first mobile station to a second mobile station without de-assigning the first mobile station. To meet the quality of service (QoS) requirements of the first mobile station, it is also desirable for the base station to be able to resume utilizing the persistently assigned resource for the first mobile station once it receives a new packet for the first mobile station. Such QoS requirements typically impose the restriction that the temporary assignment is not itself a persistent assignment, thereby requiring even more temporary assignments. These temporary assignments create additional control channel overhead. For an OFDMA communication system with a large number of VoIP mobile stations, the number of temporary assignments can be large, which can dramatically increase the control channel overhead. Thus, there is a need for making large numbers of temporary assignments, while efficiently controlling the control channel overhead, while maintaining the desired QoS for the mobile stations.

### SUMMARY OF THE INVENTION

In one aspect, the present invention provides for a method of assigning a radio resource in a wireless communication system. The method includes transmitting an assignment message to at least one mobile station including an indication of a virtual resource assignment, the virtual resource assignment corresponding to one or more virtual resources, and transmitting a remapping bitmap to the at least one mobile station, the remapping bitmap containing a bitmap that maps virtual resources to real resources.

In another aspect, the invention provides for a method of receiving a radio resource assignment in a wireless communication system. The method includes receiving an assignment message including an indication of a virtual resource assignment, the virtual resource assignment corresponding to one or more virtual resources, and receiving a remapping bitmap, the remapping bitmap containing a bitmap that maps virtual resources to real resources. The method further includes determining if one or more assigned virtual resources is being remapped to a real resource based on the remapping bitmap, and determining a real resource assignment as one or more real resources by mapping the virtual resources that have been remapped to real resources.

In yet another aspect, the present invention provides for a method of controlling quality of service (QoS) requirements for a first mobile station having a first QoS requirement and a second mobile station having a second QoS requirement comprising assigning the first mobile station having the first QoS requirement to a real resource, and assigning the second mobile station having the second QoS requirement to a virtual resource. The method further includes transmitting a remapping bitmap to the second mobile station having the second QoS requirement, the remapping bitmap providing an index relating the virtual resource to a real resource.

An advantageous feature of embodiments of the present invention is the ability of a base station to indicate temporary assignments to mobile stations reliably while minimizing the control channel overhead.

Another advantageous feature of embodiments of the present invention is the ability to detect the temporary assignment from the base station reliably.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a wireless communications network;

FIG. 2 illustrates a base station and several mobile stations from a wireless communications network;

FIGS. 3-6 illustrate an example set of OFDMA time-frequency radio resources;

FIG. 7 is an illustrative example of OFDMA assignments for four mobile stations;

FIG. 8 illustrates the control signaling for resource remapping;

FIG. 9 illustrates a channel tree for the OFDMA time-frequency resources of FIGS. 3-6;

FIGS. 10-13 are illustrative examples of resource remapping;

FIG. 14 illustrates a repeating sequence of frames;

FIG. 15 is an illustrative example of an assignment message;

FIG. 16 is an illustrative example of resource remapping in subsequent sections;

FIG. 17 is a flow chart for a preferred embodiment DL base station operation;

FIG. 18 is a flow chart for a preferred embodiment DL mobile station operation;

FIG. 19 is a flow chart for a preferred embodiment UL base station operation; and

FIG. 20 is a flow chart for a preferred embodiment UL mobile station operation.

### DETAILED DESCRIPTION OF ILLUSTRATIVE EMBODIMENTS

The present disclosure can be described by the embodiments given below. It is understood, however, that the embodiments below are not necessarily limitations to the present disclosure, but are used to describe a typical implementation of the invention.

The present invention provides a unique method and apparatus for sharing resources in a wireless system. It is understood, however, that the following disclosure provides many different embodiments, or examples, for implementing different features of the invention. Specific examples of components, signals, messages, protocols, and arrangements are described below to simplify the present disclosure. These are, of course, merely examples and are not intended to limit the invention from that described in the claims. Well known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry described herein are omitted, as such control circuits are within the skills of persons of ordinary skill in the relevant art.

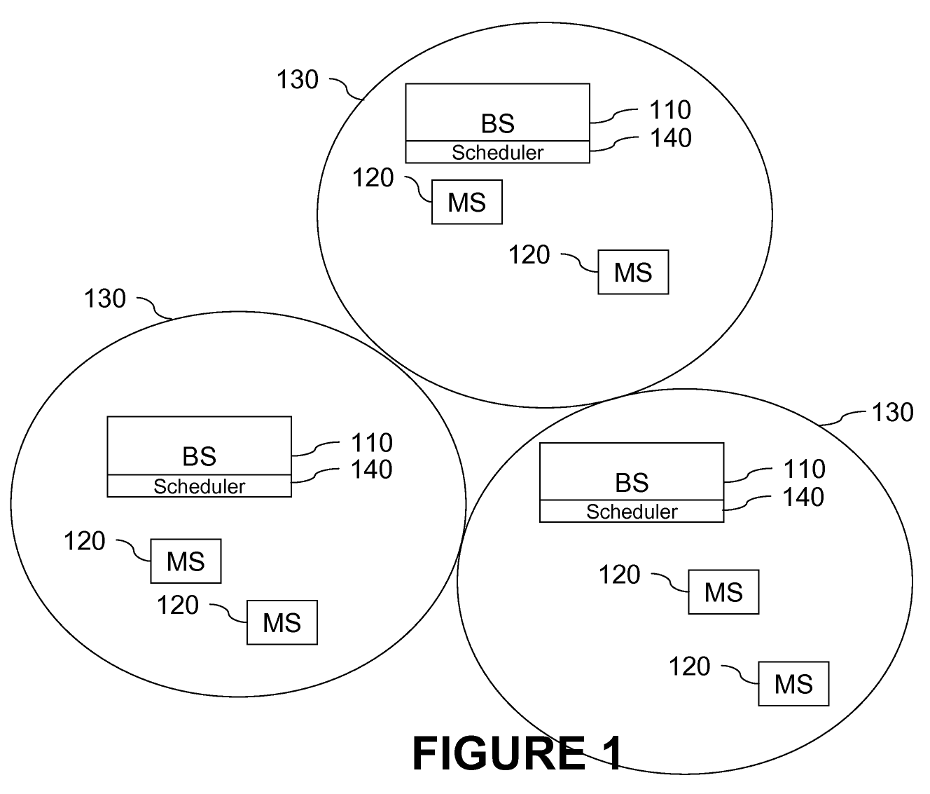

FIG. 1 is a wireless communications network comprising a plurality of base stations (BS) 110, each providing voice and/or data wireless communication service to a respective plurality of mobile stations (MS) 120. The BS is also sometimes referred to by other names such as access network (AN), access point (AP), Node-B, etc. Each BS has a corresponding coverage area 130. Referring to FIG. 1, each base station includes a scheduler 140 for allocating radio resources to the mobile stations. Exemplary wireless communication systems include, but are not limited to, Evolved Universal Terrestrial Radio Access (E-UTRA) networks, Ultra Mobile Broadband (UMB) networks, IEEE 802.16 networks, and other OFDMA based networks. In some embodiments, the network is based on a multiple access scheme other than OFDMA. For example, the network can be a frequency division multiplex access (FDMA) network wherein the time-frequency resources are divided into frequency intervals over a certain time interval, a time division multiplex access (TDMA) network wherein the time-frequency resources are divided into time intervals over a certain frequency interval, and a code division multiplex access (CDMA) network wherein the resources are divided into orthogonal or pseudo-orthogonal codes over a certain time-frequency interval.

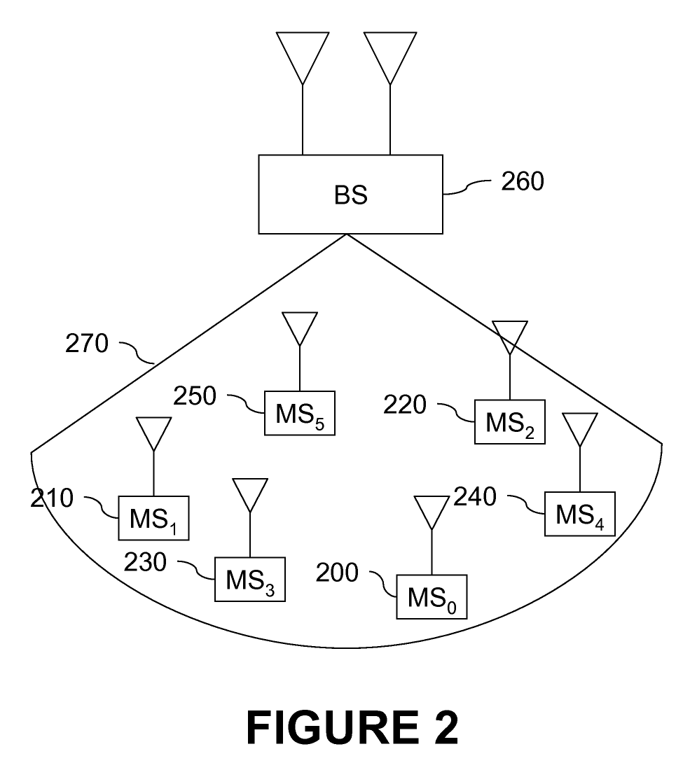

FIG. 2 illustrates one base station and several mobile stations from the wireless communications network of FIG. 1. As is known in the art, the coverage area, or cell, of a base station 260 can be divided into, typically, three sub-coverage areas or sectors, one of which is shown 270. Six exemplary mobile stations 200, 210, 220, 230, 240, 250 are in the shown coverage area. Base station 260 typically assigns each mobile station one or more connection identifiers (CID) (or another similar identifier) to facilitate time-frequency resource assignment. The CID assignment can be transmitted from a base station to a mobile station on a control channel, can be permanently stored at the mobile station, or derived based on a mobile station or base station parameter.

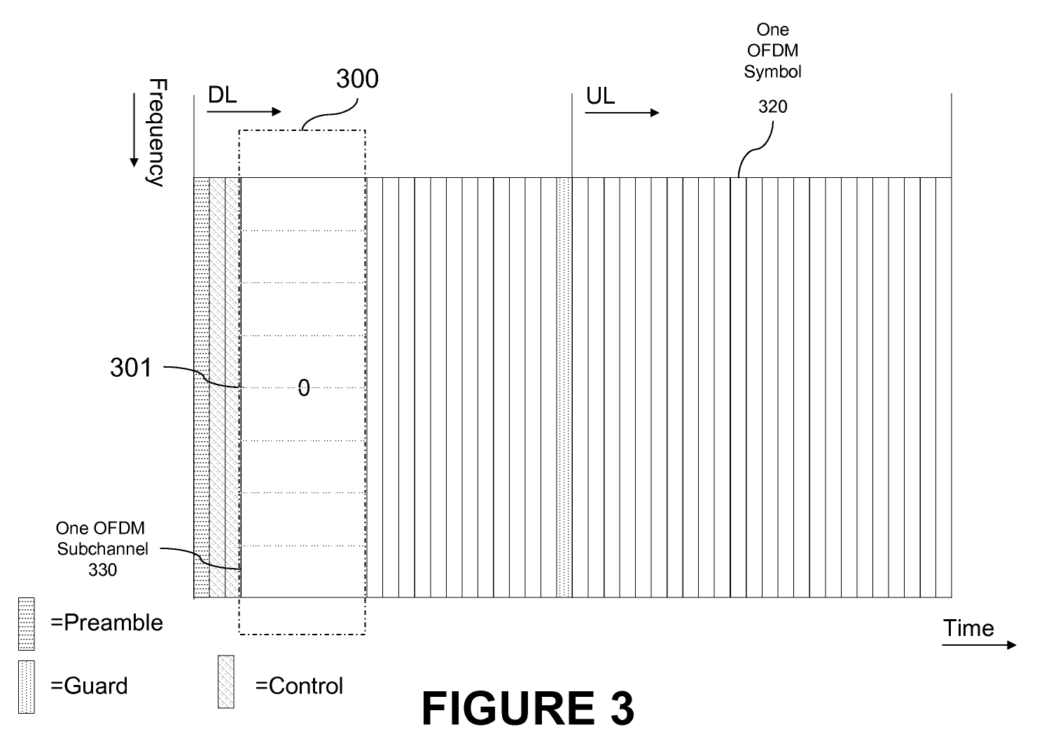

FIGS. 3-6 illustrate an example set of OFDMA time-frequency radio resources. In OFDMA systems, the time-frequency resources are divided into OFDM symbols and OFDM subcarriers for allocation by the base station scheduler to the mobile stations. In an example OFDMA system, the OFDM subcarriers are approximately 10 kHz apart and the duration of each OFDM symbol is approximately 100 μsec. Referring to FIG. 3, the time-frequency resources correspond to a time division duplex (TDD) system, such as that defined by the IEEE 802.16e standard. In this exemplary embodiment, the resources in the time domain (x-axis) are divided into two equal portions; denoted as downlink (DL), and uplink (UL). The DL and UL are further divided into 24 OFDM symbols 320. The first DL OFDM symbol is allocated for the preamble, which is used for timing and frequency synchronization by the mobile stations. The second and third DL OFDM symbols are used to transmit control information. The twenty-fourth DL OFDM symbol is allocated as a guard period. In the frequency domain (y-axis), the fourth through eleventh DL OFDM symbols are further illustrated as divided into eight OFDM subchannels 330. The OFDM subchannels 330 each contains 48 usable OFDM subcarriers that are either contiguous or distributed across a larger bandwidth, where a usable OFDM subcarrier is one that can be used for data transmission, i.e. non-pilot.

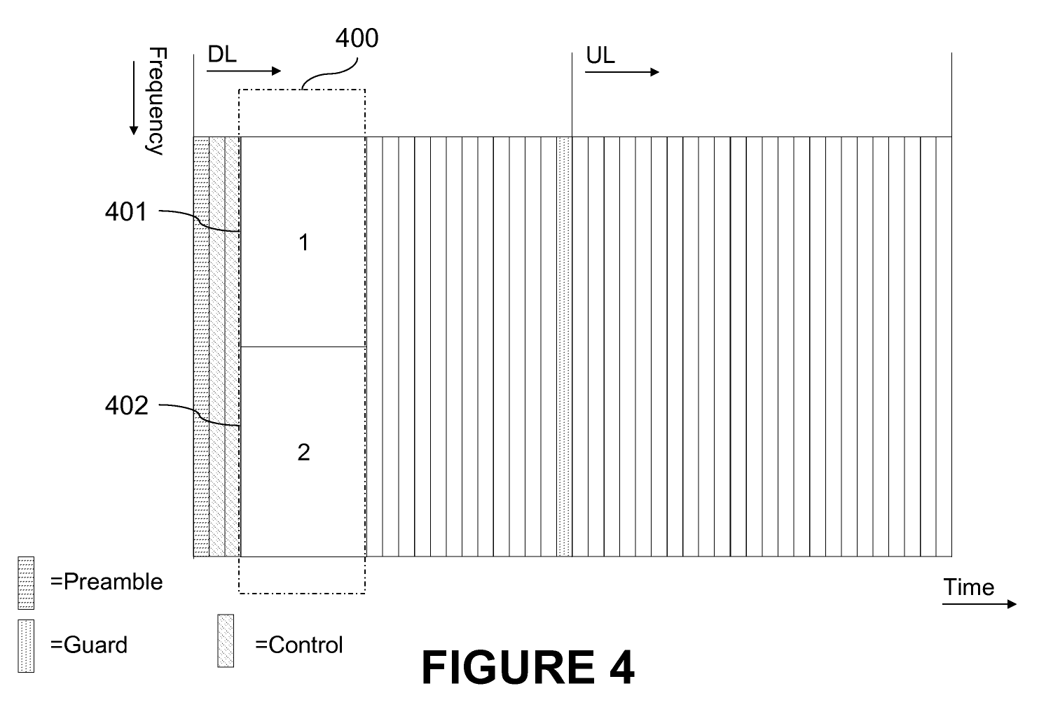

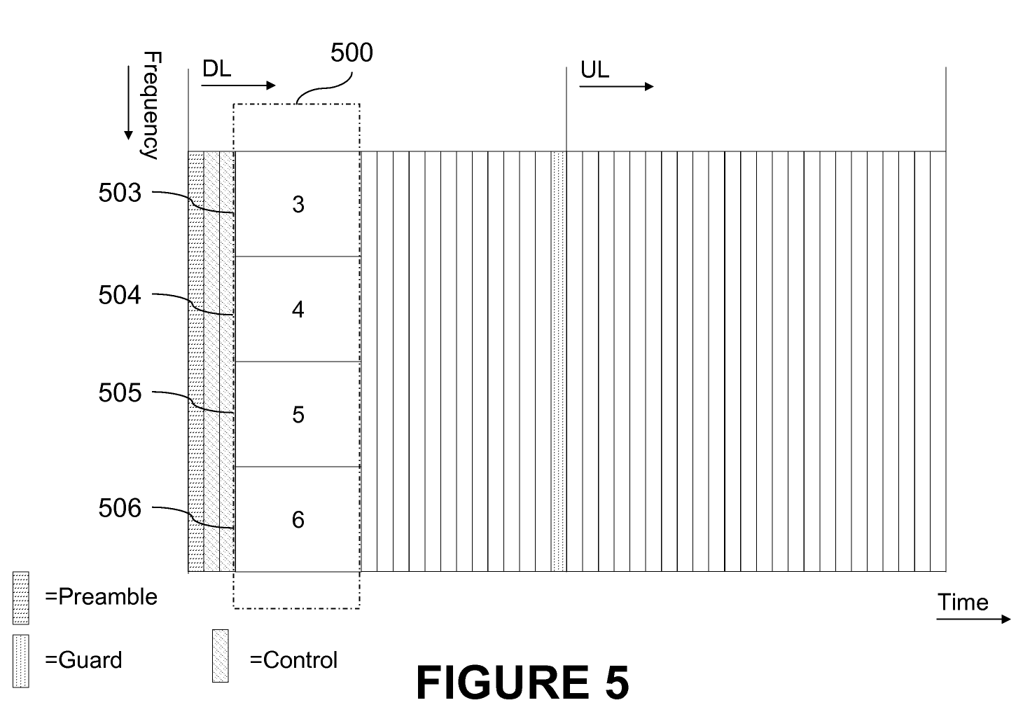

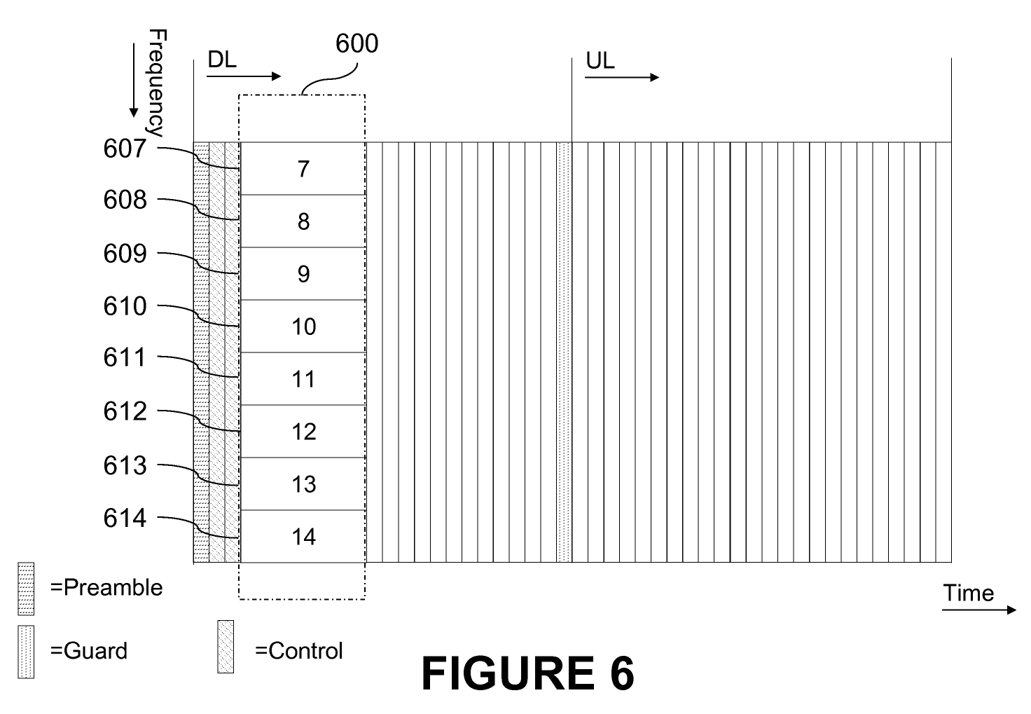

In this example, the fourth through eleventh DL OFDM symbols are allocated as a zone 300 inside which 15 distinct time-frequency resource assignments are possible. Each distinct time-frequency resource assignment is referred to as a node. The set of nodes is illustrated in FIGS. 3-6. FIG. 3 illustrates the largest time-frequency resource assignment 301, labeled as node 0. The time-frequency resource is 8 OFDM symbols by 384 usable OFDM subcarriers. FIG. 4 illustrates the two next largest time-frequency resource assignments 401, 402, labeled as nodes 1 and 2, respectively. Each time-frequency resource is 8 OFDM symbols by 192 usable OFDM subcarriers. FIG. 5 illustrates the four next largest time-frequency resource assignments 503, 504, 505, and 506, labeled as nodes 3, 4, 5, and 6, respectively. Each time-frequency resource is 8 OFDM symbols by 96 usable OFDM subcarriers. FIG. 6 illustrates the eight next largest time-frequency resource assignments 607, 608, 609, 610, 611, 612, 613, and 614 labeled as nodes 7, 8, 9, 10, 11, 12, 13, and 14, respectively. Each time-frequency resource is 8 OFDM symbols by 48 usable OFDM subcarriers. Further division of the time-frequency resources will be apparent to those skilled in the art. In FIGS. 3-6, the nodes correspond to a logical representation of the time-frequency resources of the system. Each logical time-frequency resource maps to a physical time-frequency resource. The mapping of logical time-frequency resources to physical time-frequency resources depends on which subcarrier permutation is being used, such as the subcarrier permutations defined by the IEEE 802.16 standard. The mapping of logical time-frequency resource to physical time-frequency resources can change with time and can depend on one or more parameters defined by the system. In some systems, there is a default subcarrier permutation, which is used by the base station and the mobile station until the base station sends a control channel message to alter the subcarrier permutation. Any mapping of logical time-frequency resources to physical time-frequency resources can be used as long as it is known at the base station and mobile station. For example, the logical time-frequency node 7 can map to physical OFDM symbols 4-11 and physical OFDM subcarriers 0-47 for one subcarrier permutation and can map to physical OFDM symbols 4-11 and physical OFDM subcarriers 0, 8, 16, 24 . . . 376 for a different subcarrier permutation.

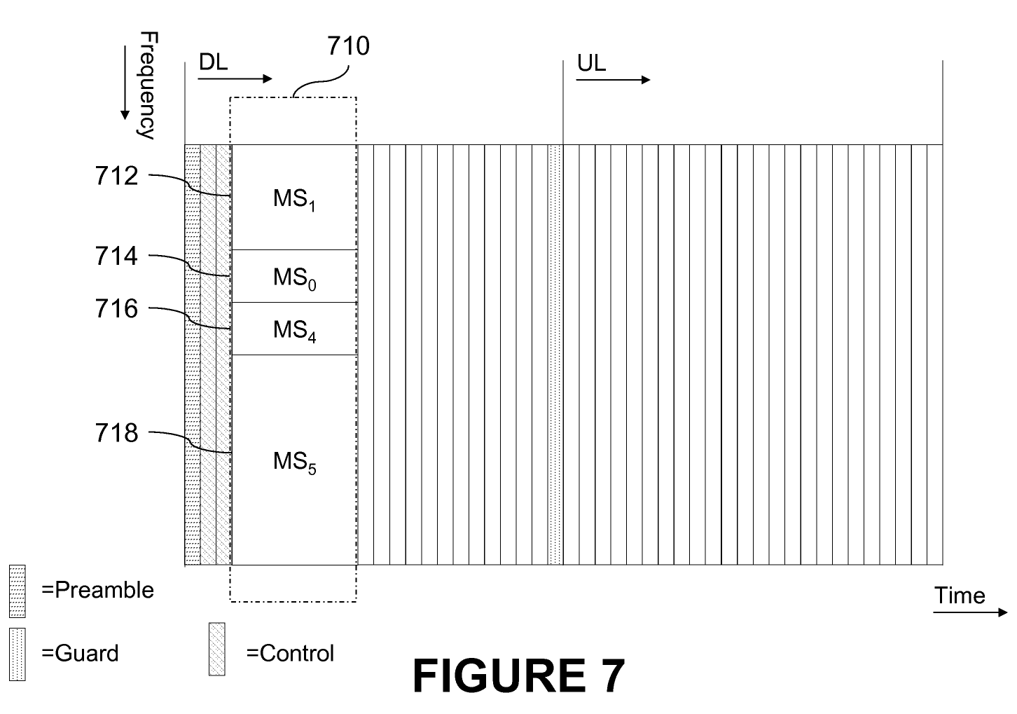

FIG. 7 is an illustrative example of OFDMA assignments for four mobile stations. Referring to FIG. 7, consider the case where 6 mobile stations MS₀, MS₁, MS₂, MS₃, MS₄, and MS₅, are situated as depicted in FIG. 2. For each frame, a scheduler, e.g., 140 (FIG. 1), determines which mobile stations will be allocated time-frequency resources and the size of the respective allocations. Then, the scheduler transmits to a mobile station an indication of the assignment for that mobile station. For example, consider that the scheduler has determined to assign node 3 to MS₁ 712, node 9 to MS₀ 714, node 10 to MS₄ 716, and node 2 to MS₅ 718. The scheduler transmits an indication of these assignments to the mobile stations using an assignment message which is transmitted on a control channel, and the mobile stations determine from the assignment message their respective time-frequency resources as shown in FIG. 7.

For the case when persistent assignments are made by the base station, there needs to be an efficient way of allocating holes left by the persistently assigned mobile stations to other mobile stations. For example, referring again to FIG. 7, consider the case where four persistent assignments are made to MS₁, MS₀, MS₄, and MS₅ as depicted in FIG. 7 and that the base station transmits the first HARQ transmission of four packets to the four mobile stations. Further, consider the case where MS₁ and MS₄ acknowledge their packets after the first transmission and where the base station does not yet have a new packet to transmit to either MS₁ or MS₄ but the base station anticipates new packets for MS₁ and MS₄ in the near future. To efficiently utilize the time-frequency resources, the base station has two holes to fill in a temporary manner, namely nodes 3 and 10. The base station can temporarily assign nodes 3 and 10 to other mobile stations, but these temporary assignments have an associated control channel overhead, which becomes less tolerable as the number of temporary assignments increases, such as may be common in a OFDMA system with many VoIP mobile stations.

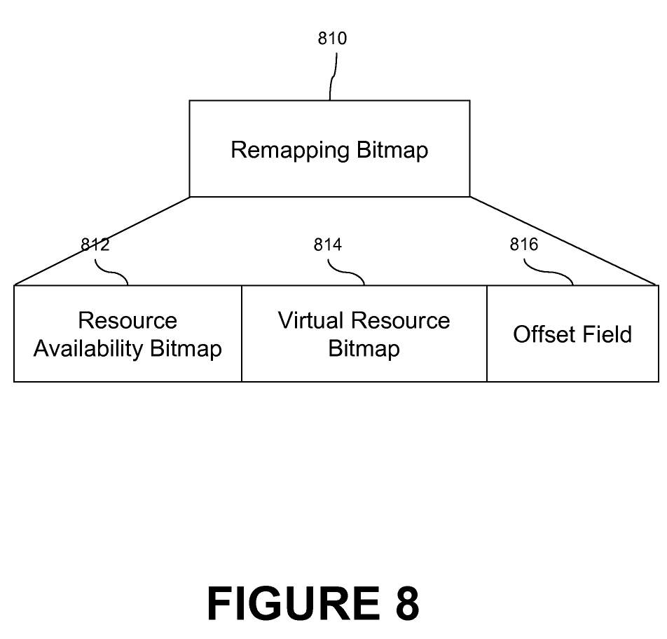

To mitigate the control channel overhead associated with temporarily assigning resources to mobile stations, FIG. 8 is provided to illustrate a novel way of assigning OFDMA resources In FIG. 8, a remapping bitmap 810 is shown. The remapping bitmap 810 is divided into three parts, a resource availability bitmap 812, a virtual resource bitmap 814, and an offset field 816. The remapping bitmap contains one or both of the resource availability bitmap 812 and the virtual resource bitmap 814, depending on the type of assignment as will be discussed in more detail later. The offset field 816 is included in some embodiments as also further detailed below.

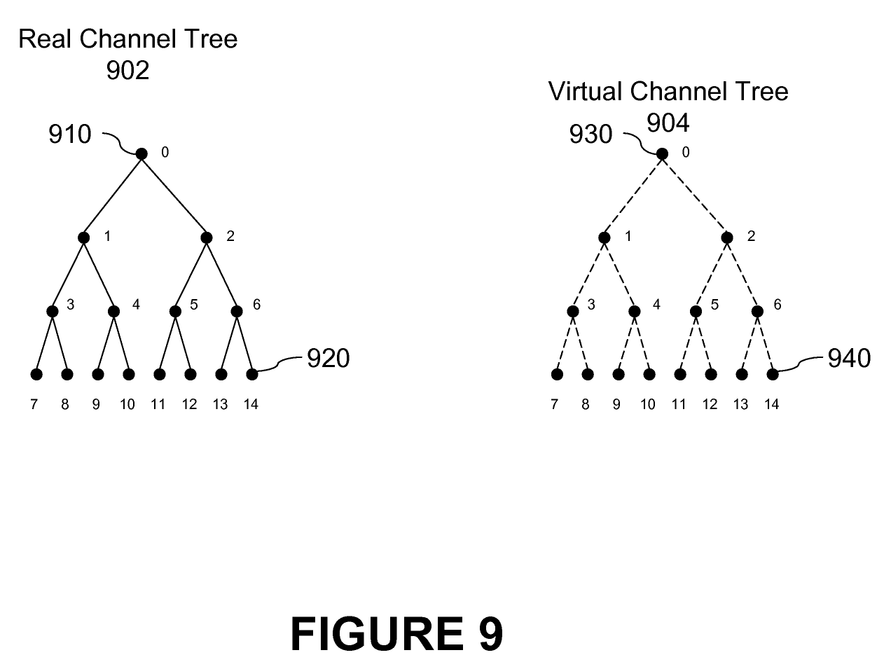

To understand the interpretation of these bitmaps, FIG. 9 is first provided to illustrate the concept of a real channel tree 902 and a virtual channel tree 904. Referring to FIG. 9, the real channel tree 902 is a logical representation of the 15 distinct time-frequency resource assignments of FIGS. 3-6. In this example, the node labels on the real channel tree correspond to the time-frequency resource labels in FIGS. 3-6. The real parent node 910 is the entire set of time-frequency resources, which is the entire zone of 8 OFDM symbols by 384 usable OFDM subcarriers (node 0 of FIG. 3). The real base nodes 920 correspond to the smallest time-frequency resource assignment possible by the base station (nodes 7-14 of FIG. 6). Each channel tree node is referred to as a channel tree index or more generally channel identifier (channel ID). In some embodiments, the base-nodes correspond to indices of spreading codes, such as those used in a code division multiple access (CDMA) system. More generally, each base node corresponds to a set of real radio resources. Base nodes can map to time slots, frequencies, codes, or any combination.

The tree structure is used to ensure than any assignment can be represented by a series of real base nodes. For example, the assignment of real node 3 is equivalent to the assignment of real base nodes 7 and 8. Virtual channel tree 904 mirrors real channel tree 902. Virtual parent node 930 corresponds to a virtual resource equivalent to the real resource which corresponds to real parent node 910 of real channel tree 902. Virtual base nodes 940 correspond to virtual resources equivalent to the real resources which correspond to real base nodes 920 of real channel tree 902. In some embodiments, the size of real channel tree 902 is different from the size of virtual channel tree 904. More particularly, the number of channel tree levels in real channel tree 902 can be different from the number of channel tree levels in virtual channel tree 904. For example, in some embodiments, virtual channel tree 904 only has only one level, the base node level. In some embodiments, virtual channel tree 904 is referred to as a leftover channel tree.

Returning to FIG. 8, resource availability bitmap 812 is a bitmap wherein each bit corresponds to one of the nodes in real channel tree 902, and virtual resource bitmap 814 is a bitmap wherein each bit corresponds to one of the nodes in virtual channel tree 904. Typically, the bits in the resource availability bitmap 812 and the virtual resource bitmap 814 correspond to the base nodes of the respective channel trees, although, in some embodiments, the bits in resource availability bitmap 812 and virtual resource bitmap 814 correspond to nodes at a higher level in the respective channel tree. If the resource availability bitmap 812 and the virtual resource bitmap 814 can map to different levels of the channel tree, an indication of which nodes the bits in the resource availability bitmap 812 and the virtual resource bitmap 814 correspond to is transmitted from the base station to the mobile station on a control channel.

In some embodiments, two or more of the resource availability bitmap 812, the virtual resource bitmap 814, and the offset field 816 are concatenated and encoded jointly for transmission by the base station. In this case, the base station may transmit an indication of which time-frequency resources will be used to transmit the concatenated packet, using a control channel, to the mobile station. This indication can be a layer three signaling message or can be transmitted as part of a periodic overhead message transmission. For example, the base station can indicate to the mobile station that a remapping bitmap 810 containing a resource availability bitmap 812, a virtual resource bitmap 814, and an offset field 816 is transmitted on control channel resource N using a layer three signaling message.

In an alternate embodiment, resource availability bitmap 812, if used, virtual resource bitmap 814, if used, and offset field 816, if used, are encoded separately for transmission by the base station. Alternatively, offset field 816 may be concatenated with either resource availability bitmap 812 or virtual resource bitmap 814 prior to encoding. As an example, for the case when there is a resource availability bitmap 812 and a virtual resource bitmap 814, resource availability bitmap 812 is encoded and transmitted on one control channel resource and virtual resource bitmap 814 is encoded on a different control channel resource. In some embodiments, the control channel resource for resource availability bitmap 812 determines the control channel resource for virtual resource bitmap 814. For example, if resource availability bitmap 812 is transmitted on control channel resource N, then virtual resource bitmap 814 is transmitted on resource N+1. In other embodiments, a type header is added to the control channel transmission to distinguish between resource availability bitmap 812 and virtual resource bitmap 814. For example, a 1 bit type header could be added to the control channel, where a ‘0’ indicates that the following information is a resource availability bitmap 812 and a ‘1’ indicates that the following information is a virtual resource bitmap 814. If downlink and uplink are simultaneously supported using remapping bitmap 810, as will be described in more detail below, a 2 bit type header could be added to the control channel, where ‘00’ indicates that the following information is a downlink resource availability bitmap 812, ‘01’ indicates that the following information is a downlink virtual resource bitmap 814, ‘10’ indicates that the following information is an uplink resource availability bitmap 812, and ‘11’ indicates that the following information is an uplink virtual resource bitmap 814.

In some embodiments, a base station implicitly indicates the type of bitmap based on the chosen control channel resource. For example, a base station can always transmit a resource availability bitmap 812 on odd control channel resources and can always transmit a virtual resource bitmap 814 on even control channel resources. If downlink and uplink are simultaneously supported using remapping bitmap 810, the base station can always transmit a DL resource availability bitmap 812 using a control channel resource X, such that mod(X,4)=0. Similarly, the base station can always transmit a DL virtual resource bitmap 814 using a control channel resource X, such that mod(X,4)=1, can always transmit an UL resource availability bitmap 812 using a control channel resource X, such that mod(X,4)=2, and can always transmit an UL virtual resource bitmap 814 using a control channel resource X, such that mod(X,4)=3.

In other alternate embodiments, the location of resource availability bitmap 812 and virtual resource bitmap 814 is indicated by a base station to a mobile station using an overhead message, which is transmitted periodically by the base station. For example, the overhead message can indicate that resource availability bitmap 812, when transmitted, is transmitted on control channel resource X, and virtual resource bitmap 814, when transmitted, is transmitted on control channel resource Y.

In another alternate embodiment, the base station distinguishes between resource availability bitmap 812 and virtual resource bitmap 814 using different scrambling for each bitmap. Similarly, a base station can distinguish between resource availability bitmap 812 and virtual resource bitmap 814 by using different cyclic redundancy check (CRC) sequences for each bitmap. For each case, a mobile station performs multiple hypothesis decoding assuming one of the known possibilities for scrambling or CRC. For example, the base station can transmit the resource availability bitmap 812 with CRC₁ and can transmit the virtual resource bitmap 814 with CRC₂. Upon receipt of a particular control channel resource, the mobile station decodes the packet and then performs a CRC using a known CRC. If the CRC check is successful for CRC₁, the mobile station determines that a resource availability bitmap 812 was transmitted. Similarly, if the CRC check is successful for CRC₂, the mobile station determines that a virtual resource bitmap 814 was transmitted.

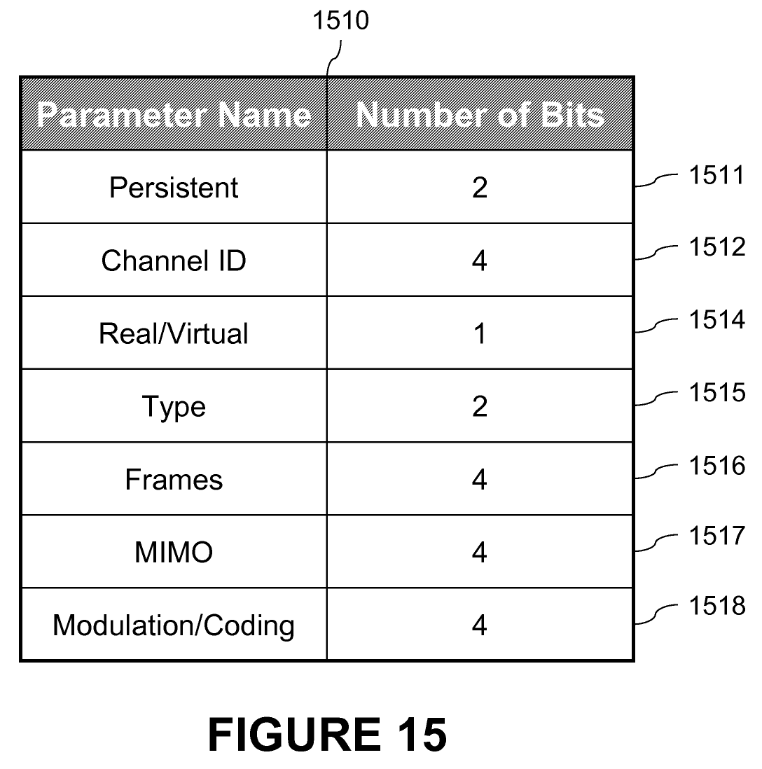

Using the concept of a real channel tree 902 and a virtual channel tree 904, the base station can assign mobile stations either real resources or virtual resources using the assignment message. In the event that the mobile station is assigned a virtual resource, the mobile station processes the remapping bitmap 810 to determine its real resource assignment. Four types of virtual resource assignment are possible, as will be described below. Further below, the manner in which a mobile station determines the type of assignment it is receiving will be described, with regard to FIG. 15.

Type 1: For type 1 assignments, the mobile station processes virtual assignments by examining the bits in resource availability bitmap 812, virtual resource bitmap 814, and offset field 816, if used. Consider the case where the bits in resource availability bitmap 812 and virtual resource bitmap 814 correspond to base nodes of their respective channel trees. A ‘1’ in resource availability bitmap 812 means the corresponding real base node is not available, and a ‘0’ in resource availability bitmap 812 means the corresponding real base node is available. A ‘1’ in virtual resource bitmap 814 means the corresponding virtual base node is being mapped to a real base node for the current frame, and ‘0’ in virtual resource bitmap 814 means the corresponding virtual base node is not being mapped to a real base node for the current frame. Note that the interpretation of ‘0’ and ‘1’ could be reversed for one or both of resource availability bitmap 812 and virtual resource bitmap 814. In this embodiment, the virtual base node corresponding to the Nth ‘1’ in virtual resource bitmap 814 is mapped to the real base node corresponding to the Nth ‘0’ in resource availability bitmap 812.

The enumeration from 1 to N can begin with the lowest numbered base node or the highest numbered base node depending on the application. Further, the enumeration can change from frame to frame. For example, the enumeration from 1 to N can begin with the lowest numbered base node in even frames and the highest numbered base node in odd frames. In some embodiments, a single bit indicator is added to the remapping bitmap to indicate whether the enumeration from 1 to N begins with the lowest numbered base node or the highest numbered base node. In some embodiments, an indication of the enumeration is transmitted from the base station to the mobile station using a different message, for example a layer three signaling message.

The offset field 816, if used, indicates an offset to this mapping. In particular, denote the value of the offset field as OS. In this case, the virtual base node corresponding to the Nth ‘1’ in virtual resource bitmap 814 is mapped to the real base node corresponding to the (N+OS)^{th} ‘0’ in resource availability bitmap 812.

If a mobile station receives a type 1 virtual assignment via the assignment message, the mobile station determines its real assignment as follows. First, the mobile station determines which virtual base nodes make up the assigned virtual node. Second, the mobile station decodes remapping bitmap 810 and extracts resource availability bitmap 812 and virtual resource bitmap 814. Third, for each virtual base node in the assignment, the mobile station determines if the bit corresponding to the virtual base node in the virtual resource bitmap is set to ‘1’. If so, the mobile station maps the virtual base node to a real base node as described above. Fourth, the mobile station determines its real assignment as the collection of real base nodes.

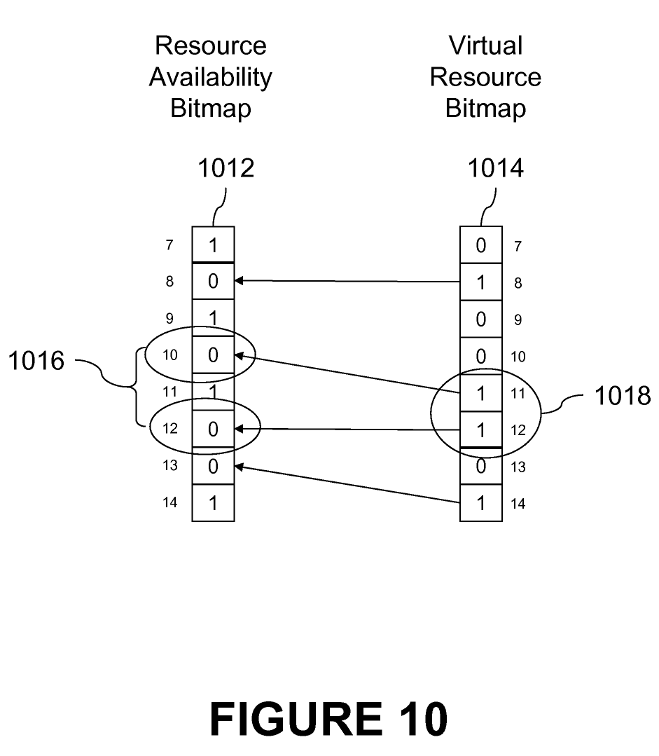

FIG. 10 is an illustrative example of the functionality of a resource availability bitmap 1012 and a virtual resource bitmap 1014 for type 1 assignments. Referring to FIG. 10, consider the case where 6 mobile stations MS₀, MS₁, MS₂, MS₃, MS₄, and MS₅, are situated as depicted in FIG. 2. Consider that the scheduler has determined to assign virtual node 8 to MS₀, virtual node 9 to MS₁, virtual node 5 to MS₂, and virtual node 14 to MS₄. Further consider the base station has assigned real base nodes 7, 9, 11, and 14 to other mobile stations and that these nodes are currently being used by these mobile stations. The remaining real base nodes are available. To transform the virtual assignments into real assignments for the current frame, the base station transmits the remapping bitmap containing the resource availability bitmap 1012 and the virtual resource bitmap 1014. Each mobile station which received a type 1 virtual resource assignment processes the remapping bitmap to determine its real resource assignment as follows:

MS₀: MS₀ determines that virtual node 8 is a virtual base node and therefore corresponds to the second bit position in the virtual resource bitmap 1014. MS₀ determines that its assigned virtual resource is being remapped to a real resource, since the bit corresponding to virtual base node 8 is a ‘1’. MS₀ determines its assigned real resource as real base node 8 based on the rule that Nth ‘1’ in the virtual resource bitmap 1014 corresponds to the Nth ‘0’ in the resource availability bitmap 1012.

MS₁: MS₁ determines that virtual node 9 is a virtual base node and therefore corresponds to the third bit position in the virtual resource bitmap. MS₁ determines that its assigned virtual resource is not being remapped to a real resource, since the bit corresponding to virtual base node 9 is a ‘0’. Hence, MS₁ need not monitor traffic for some period of time, e.g. four frames, as no resources have been assigned to MS₁.

MS₂: MS₂ determines that virtual node 5 maps to virtual base nodes 11 and 12 (see virtual channel tree 904 of FIG. 9) and therefore corresponds to the fifth and sixth bit positions 1018 in the virtual resource bitmap 1014. MS₂ determines that both of its assigned virtual resources are being remapped to real resources, since the bits corresponding to virtual base nodes 11 and 12 are ‘1’. MS₂ determines its assigned real resources 1016 as real base nodes 10 and 12 based on the rule that Nth ‘1’ in the virtual resource bitmap 1014 corresponds to the Nth ‘0’ in the resource availability bitmap 1012.

MS₄: MS₄ determines that virtual node 14 is a virtual base node and therefore corresponds to the eighth bit position in the virtual resource bitmap 1014. MS₄ determines that its assigned virtual resource is being remapped to a real resource, since the bit corresponding to virtual base node 14 is a ‘1’. MS₄ determines its assigned real resource as real base node 13 based on the rule that Nth ‘1’ in the virtual resource bitmap 1014 corresponds to the Nth ‘0’ in the resource availability bitmap 1012.

Type 2: For type 2 assignments, the mobile station processes virtual assignments by examining the bits in the resource availability bitmap 812, the virtual resource bitmap 814, and the offset field 816, if used. Consider the case where the bits in resource availability bitmap 812 and virtual resource bitmap 814 correspond to base nodes of their respective channel trees.

If a mobile station receives a type 2 virtual assignment via the assignment message, the mobile station determines its real assignment as follows. First, the mobile station determines which virtual base nodes make up the assigned virtual node. Denote the total number of virtual base nodes in the assignment as BN_{V} and the number of the first virtual base node as FBN_{V}, where the numbering of virtual base nodes begins with 1 (i.e. virtual base node 7 corresponds to FBN_{V}=1). Second, the mobile station decodes remapping bitmap 810 and extracts the resource availability bitmap 812, virtual resource bitmap 814, and offset field 816, if used. Third, the mobile station determines the number of ‘1’s in the virtual resource bitmap and adds this to the value in offset field 816, if used. This value is denoted as V. Fourth, the mobile station determines the number of ‘0’s in the resource availability bitmap. This value is denoted as R. If R is greater than or equal to V+FBN_{V}+BN_{V}−1, the mobile station then determines its assigned real base nodes as the real base nodes corresponding to the V+FBN_{V}th to V+FBN_{V}+BN_{V}−1th ‘0’s in the resource availability bitmap. If R is less than V+FBN_{V}, the mobile station determines that is not assigned any real base nodes. If R is greater than or equal to V+FBN_{V} and less than V+FBN_{V}+BN_{V}−1, the mobile station determines its assigned real base nodes as the real base nodes corresponding to the V+FBN_{V} to Rth ‘0’ in the resource availability bitmap.

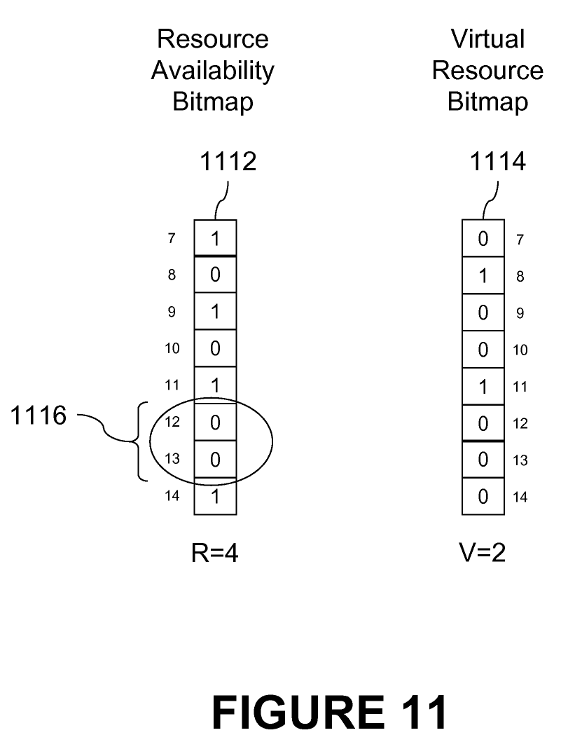

FIG. 11 is an illustrative example of the functionality of resource availability bitmap 1112 and virtual resource bitmap 1114 for type 2 assignments. Referring to FIG. 11, consider the case where 6 mobile stations MS₀, MS₁, MS₂, MS₃, MS₄, and MS₅, are situated as depicted in FIG. 2. Consider that the scheduler has determined to assign virtual node 3 to MS₀. Further consider the base station has assigned real base nodes 7, 9, 11, and 14 to other mobile stations and that these resources are currently being used by these mobile stations. The remaining real base nodes area available. To transform the virtual assignment into a real assignment for the current frame, the base station transmits a remapping bitmap containing resource availability bitmap 1112 and virtual resource bitmap 11 14. Each mobile station which received a type 2 virtual resource assignment processes the remapping bitmap to determine its real resource assignment as follows:

MS₀: MS₀ determines that virtual node 3 maps to virtual base nodes 7 and 8 (see FIG. 9). Based on this, MS₀ determines that the number of virtual base nodes in its assignment, BN_{V}, is 2 and that the first virtual base node in the assignment, FBN_{V}, is 1. MS₀ determines that the number of ‘1’s in the virtual resource bitmap 1114, V, is 2. MS₀ determines that the number of ‘0’s in the resource availability bitmap 1112 is 4. Since R is greater than or equal to V+FBN_{V}+BN_{V}−1, MS₀ determines that is assigned the real base nodes corresponding to the 3^{rd} (V+FBN_{V}) to 4^{th} (V+FBN_{V}+BN_{V}−1) ‘0’s in the resource availability bitmap, which are real base nodes 12 and 13 1116.

Type 3: For type 3 assignments, the mobile station processes virtual assignments by examining the bits in virtual resource bitmap 814 and offset field 816, if used. For type 3 assignments, resource availability bitmap 812 is not used. Consider the case where the bits in virtual resource bitmap 814 correspond to base nodes of a virtual channel tree.

If a mobile station receives a type 3 virtual assignment via the assignment message, the mobile station determines its real assignment as follows. First, the mobile station determines which virtual base nodes make up the assigned virtual node. Second, the mobile station decodes the remapping bitmap 810 and extracts the virtual resource bitmap 814 and the offset field 816, if used. Third, for each virtual base node in the assignment, the mobile station determines if the bit corresponding to the virtual base node in the virtual resource bitmap is set to ‘1’. If so, the mobile station maps the virtual base node to a real base node using the rule that the virtual base node corresponding to the Nth ‘1’ in the virtual resource bitmap is mapped to the (N+OS)th real base node, where OS is the value of the offset field 816, if used. Fourth, the mobile station determines its real assignment as the collection of real base nodes. Note that type 3 assignments are equivalent to type 1 assignments under the assumption that the resource availability bitmap for the type 1 assignment is all zeros.

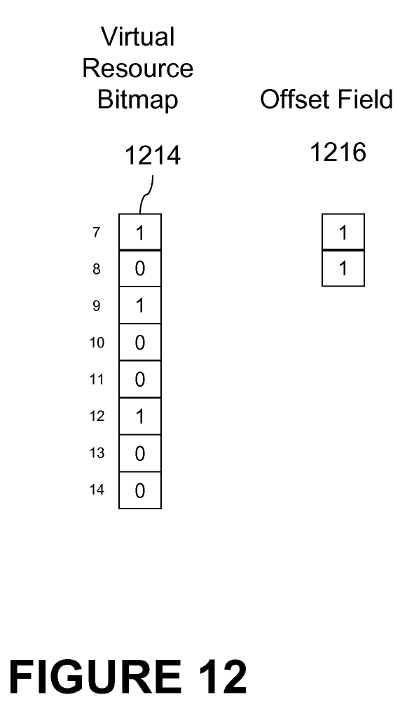

FIG. 12 is an illustrative example of a virtual resource bitmap 1214 and an offset field 1216 for type 3 assignments. Referring to FIG. 12, consider the case where 6 mobile stations MS₀, MS₁, MS₂, MS₃, MS₄, and MS₅, are situated as depicted in FIG. 2. Consider that the scheduler has determined to assign virtual node 1 to MS₀ and virtual node 2 to MS₁. To transform the virtual assignments into real assignments for the current frame, the base station transmits a remapping bitmap containing virtual resource bitmap 1214 and offset field 1216. Each mobile station which received a type 3 virtual resource assignment processes the remapping bitmap to determine its real resource assignment as follows:

MS₀: MS₀ determines that virtual node 1 maps to virtual base nodes 7, 8, 9, and 10. Based on the virtual resource bitmap, MS₀ determines that virtual base nodes 7 and 9 are being mapped to real base nodes. MS₀ determines the value of the offset field to be 3 (decimal 3 equals ‘11’). MS₀ then determines that virtual base node 7 corresponds to the 1^{st} ‘1’ in the virtual resource bitmap and is therefore mapped to the 4^{th} (4=1+3) real base node. The 4^{th} real base node is base node 10. Similarly, MS₀ determines that virtual base node 9 maps to real base node 11.

MS1: MS₁ determines that virtual node 2 maps to virtual base nodes 11, 12, 13, and 14. Based on the virtual resource bitmap, MS₁ determines that virtual base node 12 is being mapped to a real base node. MS₁ determines the value of the offset field to be 3 (decimal 3 equals ‘11’). MS₁ then determines that virtual base node 12 corresponds to the 3^{rd} ‘1’ in the virtual resource bitmap and is therefore mapped to the 6^{th} (6=3+3) real base node. The 6^{th} real base node is base node 12.

Type 4: For type 4 assignments, the mobile station processes virtual assignments by examining the bits in the resource availability bitmap 812 and the offset field 816, if used. Consider the case where the bits in the resource availability 812 correspond to base nodes of the real channel tree.

If a mobile station receives a type 4 virtual assignment via the assignment message, the mobile station determines its real assignment as follows. First, the mobile station determines which virtual base nodes make up the assigned virtual node. Denote the total number of virtual base nodes in the assignment as BN_{V} and the number of the first virtual base node as FBN_{V}, where the numbering of virtual base nodes begins with 1 (i.e. virtual base node 7 corresponds to FBN_{V}=1). Second, the mobile station decodes the remapping bitmap 810 and extracts the resource availability bitmap 812 and the offset field 816, if used. Third, the mobile station determines the value of the offset field 816, if used. This value is denoted as OS. Fourth, the mobile station determines the number of ‘0’s in the resource availability bitmap. This value is denoted as R. If R is greater than or equal to OS+FBN_{V}+BN_{V}−1, the mobile station then determines its assigned real base nodes as the real base nodes corresponding to the OS+FBN_{V}th to OS+FBN_{V}+BN_{V}−1th ‘0’s in the resource availability bitmap. If R is less than OS+FBN_{V}, the mobile station determines that is not assigned any real base nodes and hence need not monitor the frame for traffic directed to that mobile station. If R is greater than or equal to OS+FBN_{V} and less than OS+FBN_{V}+BN_{V}−1, the mobile station determines its assigned real base nodes as the real base nodes corresponding to the OS+FBN_{V} to Rth ‘0’ in the resource availability bitmap.

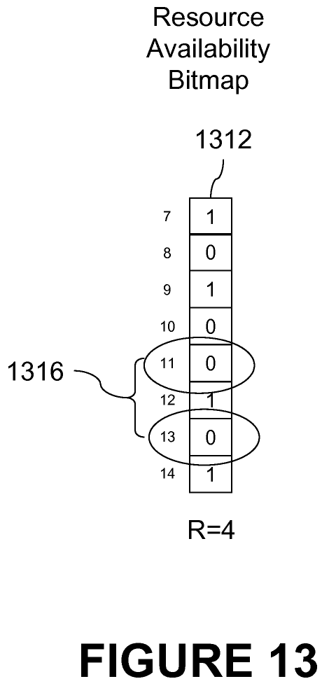

FIG. 13 is an illustrative example of the functionality of the resource availability bitmap 1312 for type 4 assignments. Referring to FIG. 13, consider the case where 6 mobile stations MS₀, MS₁, MS₂, MS₃, MS₄, and MS₅, are situated as depicted in FIG. 2. Consider that the scheduler has determined to assign virtual node 4 to MS₀. Further consider the base station has assigned real base nodes 7, 9, 12, and 14 to other mobile stations and that these nodes are currently being used by these mobile stations. The remaining real base nodes are available. To transform the virtual assignment into a real assignment for the current frame, the base station transmits the remapping bitmap containing the resource availability bitmap 1312. Each mobile station which received a type 4 virtual resource assignment processes the remapping bitmap to determine its real resource assignment as follows:

MS₀: MS₀ determines that virtual node 4 maps to virtual base nodes 9 and 10. Based on this, MS₀ determines that the number of virtual base nodes in its assignment, BN_{V}, is 2 and that the first virtual base node in the assignment, FBN_{V}, is 3. Since no offset field is present, MS₀ determines that OS is equal to 0. MS₀ determines that the number of ‘0’s in the resource availability bitmap 1312 is 4. Since R is greater than or equal to OS+FBN_{V}+BN_{V}−1, MS₀ determines that is assigned the real base nodes corresponding to the 3^{rd} (OS+FBN_{V}) to 4^{th} (OS+FBN_{V}+BN_{V}−1) ‘0’ in the resource availability bitmap, which are real base nodes 11 and 13 1316.

In some embodiments, resource availability bitmap 812 and virtual resource bitmap 814 are divided into multiple sections, wherein each section corresponds to a particular band in the frequency domain. For example, in a 5 MHz system, there could be 4 bands, where each band represents 1.25 MHz. If there are 32 resources in the 5 MHz system, then there are 8 resources in each of the 4 bands. In this embodiment, the assignment logic operates independently on each band (it can be thought of as having a resource availability bitmap 812 and a virtual resource bitmap 814 for each band which are then concatenated for transmission over the air). For example, for type 1 assignments, the virtual resource corresponding to the Nth ‘1’ in the virtual resource bitmap for the Bth band is mapped to the real resource corresponding to the Nth ‘0’ in the resource availability bitmap for the Bth band. In this way, the base station can employ frequency selective scheduling within the constraints of a remapping bitmap.

Using the four types of virtual assignments, real persistent assignments, and combinations of the above, a base station can control the QoS requirements of associated mobile stations in a wireless communication system. For virtual assignments, a base station can meet the QoS requirements of mobile stations by setting the values of the bits in resource availability bitmap 812 and virtual resource bitmap 814. As an example, consider a system where there are at least two services types having different QoS requirements. Consider that service type 1 has a QoS requirement which is delay intolerant and service type 2 has a QoS requirement which is delay tolerant. The base station can assign mobile stations having service 1 type real persistent assignments and can assign mobile stations having service type 2 virtual assignments. The base station then uses remapping bitmap 810 to indicate which virtual resources are being remapped to real resources in the current frame. Since remapping bitmap 810 is used, the number and location of the real resources devoted to mobile stations having service type 2 change from frame to frame and do not interfere with the resources used for transmitting packets to mobile stations having service type 1. In general, the base station can utilize real assignments and the four types of virtual assignments to meet different QoS requirements. This is particularly advantageous because the amount of overhead required for transmitting virtual resources is significantly lower than would be required for transmitting full assignment of real resources messages.

Additionally, using virtual assignments, the base station can control the number of resources that are used for each mobile station for each HARQ transmission by setting the values in the remapping bitmap 810. For example, in some embodiments, it is desirable to maintain the same number of resources for each HARQ transmission. The base station can guarantee this functionality by setting the values in the remapping bitmap 810.

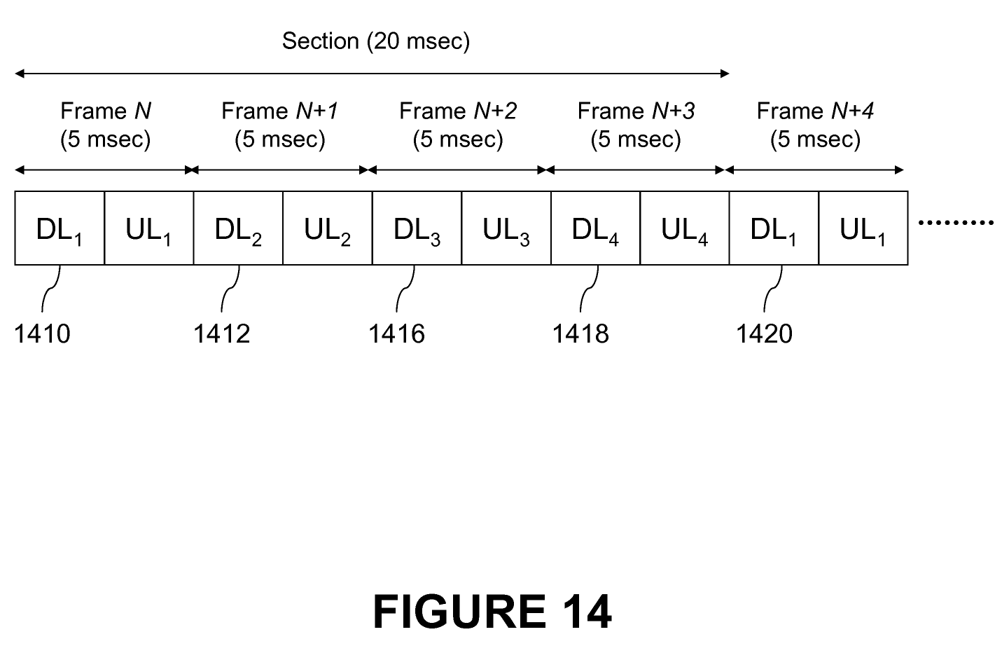

Once a virtual resource is transformed into a real resource, the real resource assignment can be a persistent assignment as described above, a non persistent assignment, or an assignment that is valid for a fixed period of time. To illustrate assignments that are valid for a fixed period of time, FIG. 14 depicts a repeating sequence of frames. Referring to FIG. 14, a frame is defined as 5 msec and contains both DL and UL sub-frames. A section is defined as 20 msec and contains four frames (four pairs of DL and UL sub-frames). The first DL sub-frame 1410 is denoted DL₁, the second DL sub-frame is denoted DL₂ 1412, the third DL sub-frame is denoted DL₃ 1416, the fourth DL sub-frame is denoted DL₄ 1418, and the fifth DL sub-frame is denoted DL₁ 1420. In this example, the DL timing is tied to a section and repeats every 20 msec. For example, for some mobile stations it may be desirable to make an assignment in DL₁ which lasts until the next occurrence of DL₁. For virtual assignments, the transformation of the virtual assignment to the real assignment could occur in every instance of DL₁, and this real assignment could be maintained for DL₂, DL₃, and DL₄. For other mobile stations, it may be desirable to transform the virtual assignment to a real assignment in each DL sub-frame. For other mobile stations, it may be desirable to transform the virtual assignment to a real assignment initially and maintain the real assignment as a persistent assignment.

To facilitate this desired flexibility, a new assignment message parameter is defined to accompany the existing assignment message parameters. FIG. 15 provides fields of an illustrative assignment message 1510. Referring to FIG. 15, the assignment message contains a two bit indication of whether the assignment is persistent or not 1511, a four bit channel ID field 1512, a one bit indication of whether the assignment is real or virtual 1514, a two bit indication of the type of assignment 1515, a four bit indication of the frames for which the assignment is valid 1516, a four bit field for indicating MIMO (multiple input multiple output) antenna related parameters 1517, and a four bit field indicating the modulation and coding 1518. One bit of persistent field 1511 is used to indicate whether virtual assignments are persistent or not, while the other bit of persistent field 1511 is used to indicate whether real assignments are persistent or not. For example, if the first bit of persistent field 1511 corresponds to virtual assignment and the second bit of persistent field 1511 corresponds to real assignments, then a value of ‘01’ for the case when real/virtual field 1514 is set to virtual, indicates that the virtual assignment is not persistent but that the determined real resource is persistent.

Channel ID field 1512 typically addresses the nodes of a channel tree. This is desirable, since it reduces the number of bits required to make time-frequency assignments. However, in some embodiments, channel ID field 1512 is itself a bitmap, wherein each bit of channel ID 1512 field corresponds to one of the nodes in the channel tree. This increases the number of bits required to make time-frequency assignments and, at the same time, increases the flexibility of the time-frequency assignments themselves. In this way, a base station can assign time-frequency resources that do not correspond to a single node from a channel tree. For example, a base station can assign a mobile station disjoint time-frequency resources with one assignment message. For example, for the channel trees of FIG. 9 902, 904, channel ID 1512 field can be 8 bits, where each bit corresponds to one of the base nodes. If a base station set the value of channel ID field 1512 to ‘10000001’, the mobile station determines that it is assigned base nodes 7 and 14. This interpretation can be applied for both real assignments and virtual assignments.

MIMO field 1517 is used to indicate the type of MIMO used by a base station, precoding scheme, antenna configuration, etc.

In some embodiments, real/virtual indication 1514 is indicated by setting the type header of the assignment message. In other embodiments, real/virtual indication 1514 is transmitted separately from the assignment message, for example in a higher layer message. In still other embodiments, real/virtual indication 1514 is conveyed to the mobile station by setting a subtree_{ID} field in an assignment message (not shown in 1510). For example, subtree_{ID}=‘0’ can be used to convey real assignments and subtree_{ID}=‘1’ can be used to convey virtual assignments. It should now be clear to those skilled in the art that there is a variety of ways of communicating the parameters delineated in FIG. 15. What is important is that one or more of these parameters are communicated to the mobile station. Not all parameters are used in all embodiments, and some parameters can be omitted based on the value of other parameters. For example, if only one type of assignment is supported, type field 1515 can be omitted. Further, in some embodiments, the type of virtual assignment is conveyed in a higher layer message and is therefore not included in assignment message 1510. Further, in some embodiments, all virtual assignments are non-persistent, so persistent field 1511 can be reduced to one bit.

Frames field 1516 is a new assignment message parameter. The length of frames field 1516 is preferably equal to the period of the desired timing. In the example of FIG. 14, the timing repeats every 20 msec, with each 20 msec containing four frames, so frames field 1516 is four bits (one bit for each frame in the section). If N is denoted as the frame index in which assignment message 1510 is received, the first bit of frames field 1516 corresponds to frame N, frame N+4, frame N+8, etc, the second bit of frames field 1516 corresponds to frame N+1, frame N+5, frame N+9, etc, the third bit of frames field 1516 corresponds to frame N+2, frame N+6, frame N+10, etc, and the fourth bit of frames field 1516 corresponds to frame N+3, frame N+7, frame N+11, etc. Any other mapping of bits to frame number can be used as long as it is known at the base station and the mobile station. For example, the bit positions of the frames field can be fixed with respect to a known boundary. In particular, if a section boundary exists, the first bit of the frames field can represent the first frame in the section, the second bit in the frames field can represent the second frame in the section, etc.

For virtual assignments, when a bit in the frames field 1516 is set to ‘1’ for a particular frame, the mobile station decodes the remapping bitmap to determine its real assignment. When a bit in the frames field 1516 is set to ‘0’ for a particular frame, the mobile station assumes the same resource that was determined the last time remapping bitmap was processed. The frames field can also be applied to real assignments. For real assignments, when a bit in the frames field is set to ‘1’ for a particular frame, the real assignment is valid for that frame. When a bit in the frames bitmap is set to ‘0’ for a particular frame, the real assignment is not valid for that frame. Combining the functionality of the frames bitmap for real and virtual assignments, the base station may assign a mobile station a real resource for some frames and a virtual resource for other frames for transmission of the same packet. In this case, real assignments take precedence over virtual assignments.

For example, the base station may assign real resource 4 with the frames field equal to ‘1000’ and virtual resource 6 with frames field equal to ‘0100’ to the same mobile station for the transmission of a series of VoIP packets. In this case, the real resource 4 can be reserved for transmitting the first HARQ transmission of each VoIP packet. If the mobile station is unable to decode the packet after the first HARQ transmission, the mobile station decodes the remapping bitmap to transform its assigned virtual resource to a new real resource for HARQ transmission 2, 3, and 4.

In some embodiments, the frames field is omitted to minimize control channel overhead. For example, the base station and mobile station can always interpret virtual assignments as having a frames field of ‘1000’ even if a frames field is not transmitted as part of the assignment message. In other embodiments, the frames field is included in a higher layer message, which is transmitted from the base station to the mobile station separately from the assignment message. In other embodiments, a subset of the possible values of the frames field is encoded. For example, the frames field could be a one bit indication, with ‘1’ representing ‘1111’ and ‘0’ representing ‘1000’.

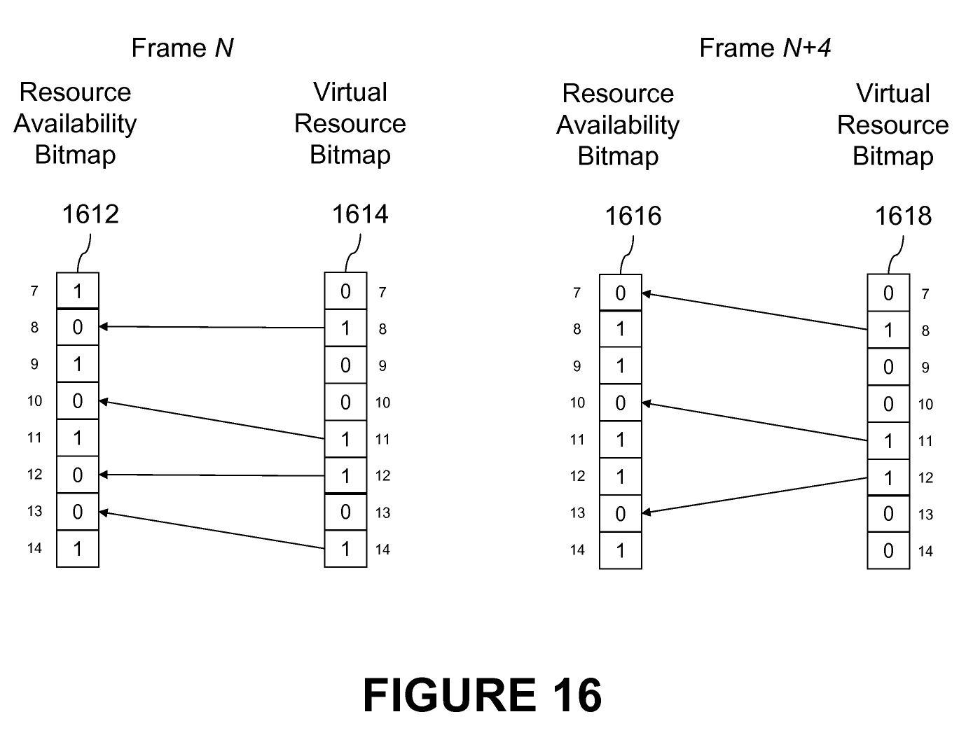

FIG. 16 is provided to illustrate the operation of a frames field for type 1 virtual resource assignments. Consider that the base station has assigned MS₀ to virtual resource 8 in frame N with the frames field equal to ‘1000’. During frame N, exemplary mobile station MS₀ must process the remapping bitmap, since the frames field has a ‘1’ in the position corresponding to frame N. MS₀ determines that virtual node 8 is a base node and therefore corresponds to the second bit position in the virtual resource bitmap 1614. MS₀ determines that its assigned virtual resource is being remapped to a real resource, since the bit corresponding to virtual base node 8 is a ‘1’. MS₀ determines its assigned real resource as real base node 8 based on the rule for type 1 assignments that the Nth ‘1’ in the virtual resource bitmap 1614 corresponds to the Nth ‘0’ in the resource availability bitmap 1612. For frames N+1, N+2, and N+3, the mobile station maintains real resource 8, since the frames field has a ‘0’ in the positions corresponding to frames N+1, N+2, and N+3. During frame N+4, the mobile station must process the remapping bitmap again, since the frames field has a ‘1’ in the position corresponding to frame N+4. MS₀ determines that virtual node 8 is a base node and therefore corresponds to the second bit position in the virtual resource bitmap 1318. MS₀ determines that its assigned virtual resource is being remapped to a real resource, since the bit corresponding to virtual base node 8 is a ‘1’. MS₀ determines its assigned real resource as real base node 7 based on the rule for type 1 assignments that the Nth ‘1’ in the virtual resource bitmap 1618 corresponds to the Nth ‘0’ in the resource availability bitmap 1616. For frames N+5, N+6, and N+7, the mobile station maintains real resource 7, since the frames field has a ‘0’ in the positions corresponding to frames N+5, N+6, and N+7. This process is repeated for subsequent frames.

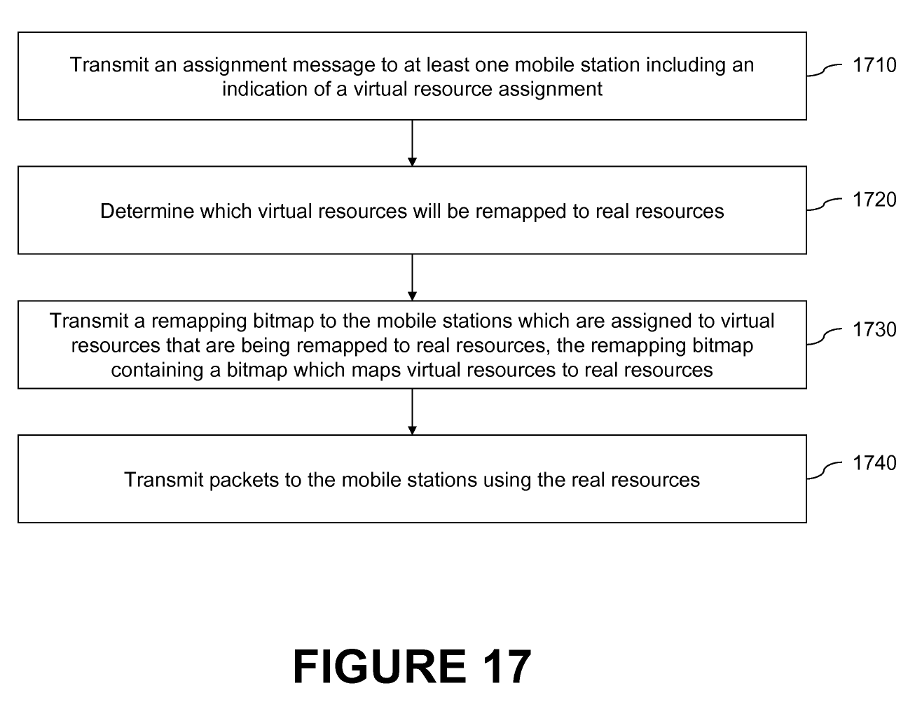

FIG. 17 is a flow chart for DL base station operation. Referring to FIG. 17, at step 1710, the base station transmits an assignment message to at least one mobile station including an indication of a virtual resource assignment. The indication of a virtual resource assignment can be included in the assignment message itself as illustrated in FIG. 15, can be derived from the channel ID, or can be indicated in a higher layer message. In some embodiments, the base station assigns the mobile station two connection identifiers (CID). One CID is used for making real assignments and the other CID is used for making virtual assignments. The virtual resource assignment corresponds to one or more virtual resources. At step 1720, the base station scheduler determines which virtual resources will be remapped to real resources. At step 1730, the base station transmits a remapping bitmap to the mobile stations which are assigned to virtual resources that are being remapped to real resources, the remapping bitmap containing a bitmap which maps virtual resources to real resources. At step 1740, the base station transmits packets to the mobile stations using the real resources.

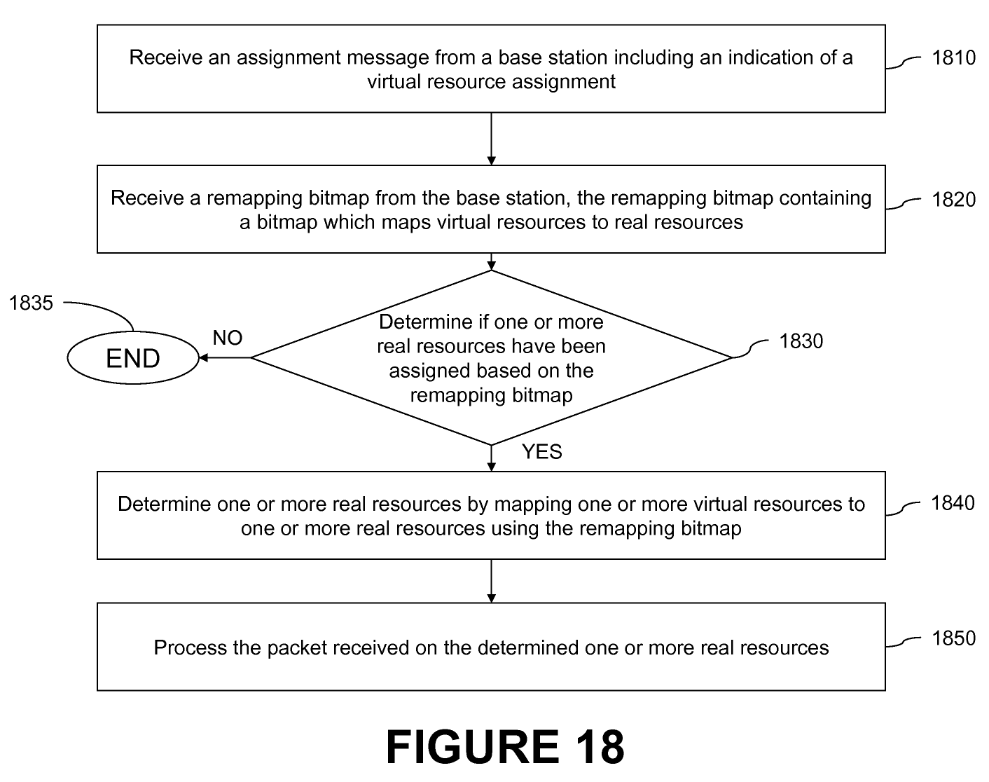

FIG. 18 is a flow chart for DL mobile station operation. Referring to FIG. 18, at step 1810, the mobile station receives an assignment message from a base station including an indication of a virtual resource assignment. The virtual resource assignment corresponds to one or more virtual resources. At step 1820, the mobile station receives a remapping bitmap from the base station, the remapping bitmap containing a bitmap which maps virtual resources to real resources. At step 1830, the mobile station determines if one or more real resources have been assigned based on the remapping bitmap. If no, the flow chart ends at 1835. If yes, the flow chart continues to step 1840, where the mobile station determines one or more real resources by mapping one or more virtual resources to one or more real resources using the remapping bitmap. At step 1850, the mobile station processes a packet received on the determined one or more real resources.

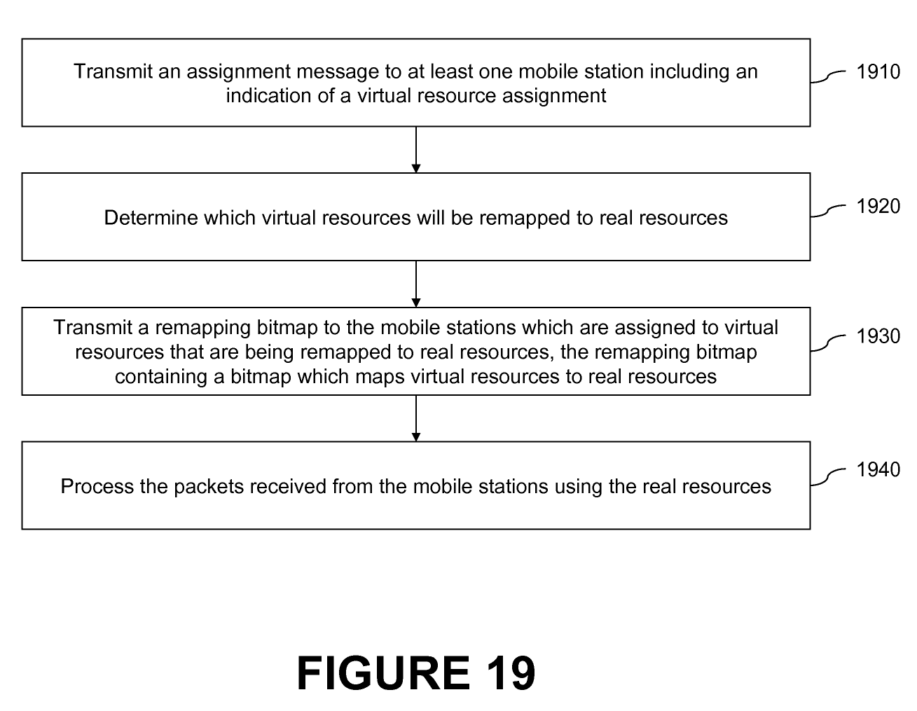

FIG. 19 is a flow chart for UL base station operation. Steps 1910, 1920, and 1930 are the same as steps 1710, 1720, and 1730 of FIG. 17, as these steps occur during the DL sub-frame. At step 1940, for UL operation, the base station processes the packets received from the mobile stations using the real resources.

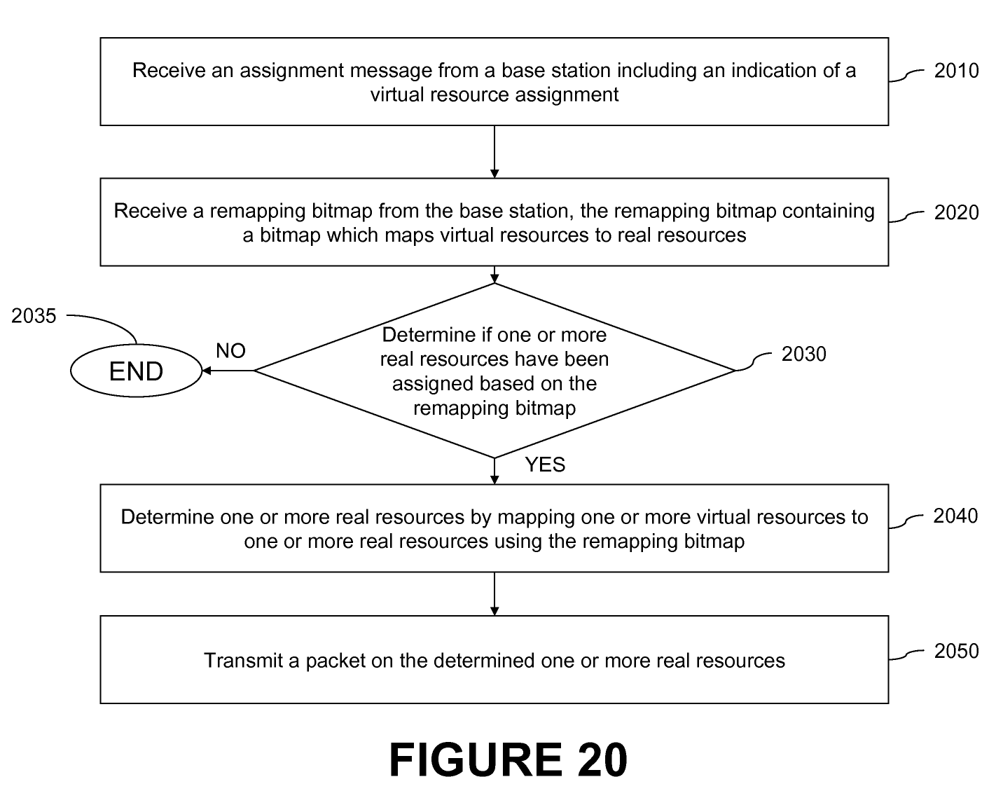

FIG. 20 is a flow chart for UL mobile station operation. Steps 2010, 2020, 2030, 2035, and 2040 are the same as steps 1810, 1820, 1830, 1835, and 1840 of FIG. 15 as these steps occur during the DL sub-frame. At step 2050, for UL operation, the mobile station transmits a packet on the determined one or more real resources.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method of assigning a radio resource in a wireless communication system, the method comprising:
transmitting an assignment message to at least one mobile station including an indication of a virtual resource assignment, the virtual resource assignment corresponding to one or more virtual resources; and
transmitting a remapping bitmap to the at least one mobile station, the remapping bitmap containing a bitmap that maps virtual resources to real resources

2. The method of claim 1, further including transmitting a second assignment message to at least one second mobile station including an indication of a real resource assignment.

3. The method of claim 2, wherein the assignment message and the second assignment message have a substantially identical format that includes an indication of whether the assignment is an assignment real resources or of virtual resources.

4. The method of claim 1, wherein the indication of a virtual resource assignment is transmitted using an index to a virtual channel tree.

5. The method of claim 1, wherein the remapping bitmap is comprised of at least one of a resource availability bitmap and a virtual resource bitmap, the resource availability bitmap representing real resources and the virtual resource bitmap representing virtual resources.

6. The method of claim 5, wherein each bit in the resource availability bitmap corresponds to a node from a real channel tree.

7. The method of claim 5, wherein each bit in the virtual resource bitmap corresponds to a node from a virtual channel tree.

8. The method of claim 6, wherein each node of the real channel tree further corresponds to a specific portion of available time-frequency resources.

9. The method of claim 5, wherein the virtual resource corresponding to the Nth ‘1’ in the virtual resource bitmap corresponds to the real resource corresponding to the Nth ‘0’ in the resource availability bitmap.

10. The method of claim 1, further comprising transmitting a packet to the at least one mobile station using the real resources.

11. The method of claim 1, further comprising receiving a packet from the at least one mobile station using the real resources.

12. A method of receiving a radio resource assignment in a wireless communication system, the method comprising:
receiving an assignment message including an indication of a virtual resource assignment, the virtual resource assignment corresponding to one or more virtual resources;
receiving a remapping bitmap, the remapping bitmap containing a bitmap that maps virtual resources to real resources;
determining if one or more assigned virtual resources is being remapped to a real resource based on the remapping bitmap; and
determining a real resource assignment as one or more real resources by mapping the virtual resources that have been remapped to real resources.

13. The method of claim 12, further comprising transmitting a packet to a base station using the one or more real resources.

14. The method of claim 12, wherein the indication of a virtual resource assignment is transmitted using an index to a virtual channel tree.

15. The method of claim 12, further comprising receiving a packet from a base station using the one or more real resources.

16. The method of claim 12, wherein at least one of the assignment message and the remapping bitmap is received from a base station.

17. A method of controlling quality of service (QoS) requirements for a first mobile station having a first QoS requirement and a second mobile station having a second QoS requirement, the method comprising:
assigning the first mobile station having the first QoS requirement to a real resource;
assigning the second mobile station having the second QoS requirement to a virtual resource; and
transmitting a remapping bitmap to the second mobile station having the second QoS requirement, the remapping bitmap providing an index relating the virtual resource to a real resource.

18. The method of claim 17, wherein the first QoS requirement is delay intolerant and the second QoS requirement is delay tolerant.

19. The method of claim 17, wherein the step of assigning the first mobile station having the first QoS requirement to a real resource includes transmitting an assignment message to the first mobile station on a control channel.

20. The method of claim 17, wherein the steps of assigning the first mobile station having the first QoS requirement to a real resource and assigning the second mobile station having the second QoS requirement to a virtual resource are accomplished using a common assignment message format wherein the assignment message format includes an indication of whether the assignment is an assignment of real resources or an assignment of virtual resources.
